(19) United States
(12) Patent Application Publication
(10) Pub. No.: US 2010/0103575 A1
(43) Pub. Date: Apr. 29, 2010

(54) Floating protection circuit and photo-flash capacitor charger thereof

(76) Inventors: Yung-Chun Chuang, Taipei City (TW); Yu-Min Sun, Taipei County (TW); Chien-Chuan Chung, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/350,248

(22) Filed: Jan. 8, 2009

(30) Foreign Application Priority Data
Oct. 24, 2008 (TW) 097140809

(51) Int. Cl. H02H 3/00

(52) U.S. Cl. 361/79

(57) ABSTRACT

A floating protection circuit is utilized for a photo-flash capacitor charger. The floating protection circuit includes a comparator and a timer. The comparator is coupled between two feedback resistors of the photo-flash capacitor charger for receiving a feedback voltage. When the feedback voltage is lower than an offset voltage, the comparator outputs a reset signal. If the timer does not receive the reset signal for a predetermined time, the timer outputs a turn-off signal to a switch control circuit of the photo-flash capacitor charger to shut down the switch control circuit.

### BACKGROUND OF THE INVENTION

1. Field of the Invention

The present invention relates to a floating protection circuit, and more particularly, to a floating protection circuit applied to a photo-flash capacitor charger.

2. Description of the Prior Art

Please refer to FIG. 1. FIG. 1 is a diagram of a photo-flash capacitor charger 100 according to the prior art. As shown in FIG. 1, the photo-flash capacitor charger 100 comprises a transformer 110, a switch control circuit 120, a comparator CMP₁, two feedback resistors R_{FB1}, R_{FB2}, a diode D₁, a transistor Q₁, and an output capacitor C_{OUT}. The photo-flash capacitor charger 100 is utilized for increasing an input voltage source V_{DD} (outputs the voltage V_{DD}) to generate an output voltage source V_{OUT} (outputs the voltage V_{OUT}), which is utilized for providing voltage needed for a photo-flash unit to flash.

Generally speaking, the output voltage V_{OUT} should be approximately 300V in order to make the photo-flash unit flash. However, as the input voltage source V_{DD} is typically provided by a battery, the voltage V_{DD} is around 5V. Thus, the photo-flash capacitor charger 100 increases the 5 Volts of the voltage source V_{DD} to 300V to allow the photo-flash unit to flash. Besides, the voltage source V_{SS} may be seen as ground.

The transformer 110 comprises a primary winding 111 and a secondary winding 112. The primary winding 111 is coupled between the voltage source V_{DD} and the transistor Q₁. The secondary winding 112 is coupled between the output voltage source V_{OUT} and the voltage source V_{SS}. More particularly, the secondary winding 112 is connected to the output voltage source V_{OUT} through the diode D₁.

The transistor Q₁ may be an N-channel Metal Oxide Semiconductor (NMOS) transistor, and is coupled between the primary winding 111 and the voltage source V_{SS}. When the transistor Q₁ is turned on, the primary winding 111 is connected to the voltage source V_{SS} through the transistor Q₁, such that a current I is generated by the voltage source V_{DD} for charging the primary winding 111; when the transistor Q₁ is turned off, the current I built up in the primary winding 111 begins to discharge through the secondary winding 112 to charge the output capacitor C_{OUT} through the diode D₁. Through this charge/discharge mechanism, the output voltage V_{OUT} is steadily increased to the required voltage, e.g. 300V.

The feedback resistors R_{FB1} and R_{FB2} are coupled between the diode D₁ and the voltage source V_{SS} for providing a feedback voltage V_{FB}, which is divided from the output voltage V_{OUT}.

The comparator CMP₁ compares a reference voltage V_{REF} and the feedback voltage V_{FB} for generating a switch enabling signal S_{EN} accordingly. The switch enabling signal S_{EN} has two levels, “enabled” and “disabled,” for controlling on/off status of the transistor Q₁. More particularly, when the feedback voltage V_{FB} is lower than the reference voltage V_{REF}, the comparator CMP₁ outputs the switch enabling signal S_{EN} as enabled; when the feedback voltage V_{FB} is higher than the reference voltage V_{REF}, the comparator CMP₁ outputs the switch enabling signal S_{EN} as disabled.

The switch control circuit 120 is coupled to a source of the transistor Q₁, a gate of the transistor Q₁, and an output end of the comparator CMP₁. The switch control circuit 120 receives switch voltage V_{SW} through the source of the transistor Q₁, and receives switch enabling signal S_{EN} through the comparator CMP₁. The switch control circuit 120 generates switch control signal S_{SW} according to the switch voltage V_{SW} and the switch enabling signal S_{EN}. More particularly, when the switch enabling signal S_{EN} indicates “enabled,” the switch control circuit 120 generates the switch control signal S_{SW} according to the switch voltage V_{SW}; when the switch enabling signal S_{EN} indicates “disabled,” the switch control circuit 120 does not generate the switch control signal S_{SW}, keeping the transistor Q₁ in the off state, such that the primary winding 111 cannot be charged further. Besides, the switch control signal S_{SW} is a periodic signal.

However, when the connection between the feedback resistors R_{FB1} and R_{FB2} is broken (for example, the resistor R_{FB1} is improperly soldered), the feedback voltage V_{FB} is kept at a low voltage level, e.g. ground, 0V, through the feedback resistor R_{FB2} by the voltage source V_{SS}, which makes the comparator CMP₁ keep outputting the switch enabling signal S_{EN} that indicates “enabled”, causing the output voltage V_{OUT} increasing without limit. Consequently, the components of the photo-flash capacitor charger 100 are damaged by the over-high voltage V_{OUT}, which is inconvenience to users.

### SUMMARY OF THE INVENTION

The present invention provides a floating protection circuit utilized for a photo-flash capacitor charger. the photo-flash capacitor charger has a switch control circuit, a transistor, a transformer, a diode, a first comparator, a first feedback resistor, and a second feedback resistor. The floating protection circuit is coupled to the switch control circuit. The switch control circuit is coupled to a control end of the transistor for outputting a switch control signal. The transistor has a first end, a second end, and the control end. The transistor couples the first end of the transistor to the second end of the transistor according to the switch control signal. A switch voltage is on the first end of the transistor. The transformer has a primary winding and a secondary winding. The first end of the transistor is coupled to a first end of the primary winding of the transformer. A second end of the primary winding of the transformer is coupled to a second voltage source. A first end of the secondary winding of the transformer is coupled to a positive end of the diode. A second end of the secondary winding is coupled to the first voltage source. The first feedback resistor is coupled between the positive end of the diode and the second feedback resistor. The second resistor is coupled between the first feedback resistor and the first voltage. The first comparator has a positive input end, a negative input end, and an output end. The positive input end of the comparator is coupled between the first feedback resistor and the second feedback resistor for receiving a feedback voltage. The negative input end of the first comparator receives a reference voltage. The comparator compares the reference voltage and the feedback voltage and accordingly generating a result. The switch control circuit outputs the switch control signal according to the switch voltage and the result. The floating protection circuit comprises a timer, comprising a reset end, for receiving a reset signal; and an output end, coupled to the switch control circuit, for outputting a turn-off signal; wherein when the timer does not receive the reset signal for a predetermined time, the timer outputs the turn-off signal; wherein when the switch control circuit receives the turn-off signal, the switch control circuit is shut down; and a second comparator, comprising a positive input end, coupled between the first feedback resistor and the second resistor for receiving the feedback voltage; a negative input end for receiving an offset voltage; and an output end for outputting the reset signal; wherein when the feedback voltage is lower than the offset voltage, the second comparator outputs the reset signal; wherein the offset voltage is at a negative voltage level.

The present invention further provides a photo-flash capacitor charger with floating protection. The photo-flash capacitor charger comprises a transformer, comprising a primary winding, comprising a first end; and a second end, coupled to a second voltage source; and a secondary winding, comprising a first end; and a second end, coupled to a first voltage source; a diode, coupled to the first end of the secondary winding for outputting an output voltage; a transistor, comprising a first end, coupled to the first end of the primary winding; a second end, coupled to the first voltage source; and a control end for receiving a switch control signal; a first feedback resistor coupled to a positive end of the diode; a second feedback resistor, coupled between the first feedback resistor and the first voltage source, for outputting a feedback voltage; a first comparator, comprising a positive input end, coupled between the first feedback resistor and the second feedback resistor, for receiving the feedback voltage; a negative input end, for receiving a reference voltage; and an output end, the first comparator comparing the reference voltage and the feedback voltage and outputting a result at the output end of the first comparator; a switch control circuit, coupled to the output end of the first comparator, the control end of the transistor, and the first end of the transistor, for outputting the switch control signal according to the result and the switch voltage; and a floating protection circuit, comprising a timer, comprising a reset end for receiving a reset signal; and an output end, coupled to the switch control circuit, for outputting a turn-off signal; wherein when the timer does not receive the reset signal for a predetermined time, the timer outputs the turn-off signal; wherein when the switch control circuit receives the turn-off signal, the switch control circuit is shut down; and a second comparator, comprising a positive input end, coupled between the first feedback resistor and the second feedback resistor, for receiving the feedback voltage; a negative input end, for receiving an offset voltage; and an output end, for outputting the reset signal; wherein when the feedback voltage is lower than the offset voltage, the second comparator outputs the reset signal; wherein the offset voltage is at a negative voltage level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a photo-flash capacitor charger according to the prior art.

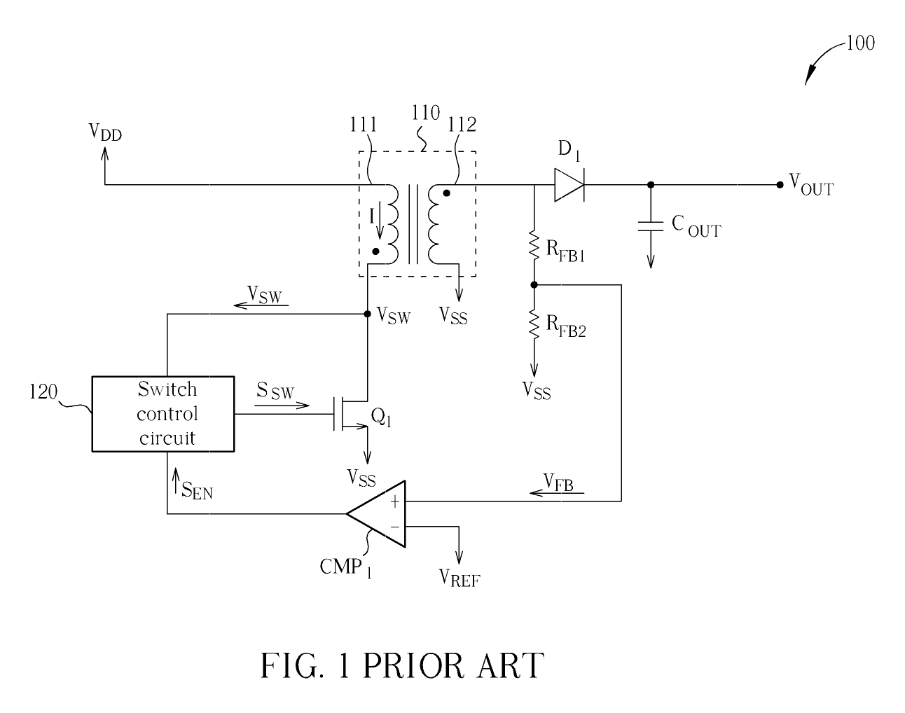

FIG. 2 is a diagram of a photo-flash capacitor charger with floating protection of the present invention.

FIG. 3 is a timing diagram illustrating the relation between the feedback voltage, the reset signal, and the turn-off signal of the present invention.

### DETAILED DESCRIPTION

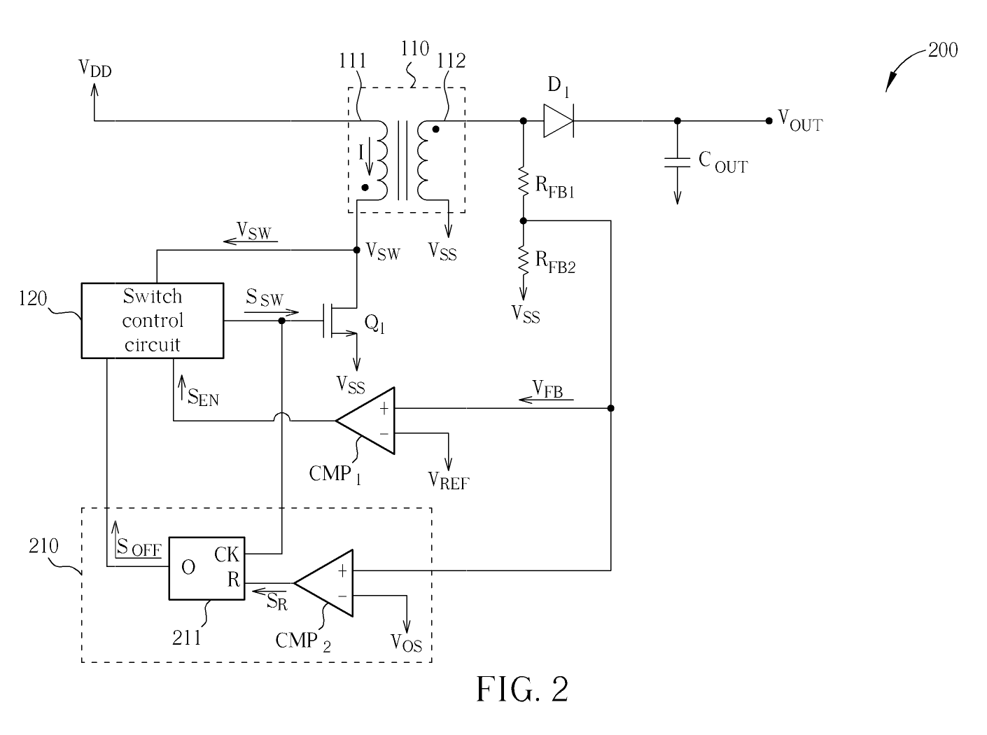

Please refer to FIG. 2, which is a diagram of a photo-flash capacitor charger 200 with floating protection. As shown in FIG. 2, the photo-flash capacitor charger 200 has structure similar to the photo-flash capacitor charger 100 of the prior art. However, the photo-flash capacitor charger 200 further comprises a floating protection circuit 210. The details are explained as follows.

The floating protection circuit 210 comprises a comparator CMP₂ and a counter 211.

The comparator CMP₂ comprises a positive input end, a negative input end, and an output end. The positive input end of the comparator CMP₂ is coupled between the resistors R_{FB1} and R_{FB2} for receiving the feedback voltage V_{FB}; the negative input end of the comparator CMP₂ is utilized for receiving an offset voltage V_{OS}; the output end of the comparator CMP₂ is utilized for outputting a reset signal S_{R}.

When the feedback voltage V_{FB} is lower than the offset voltage V_{OS}, the reset signal S_{R} is logic 0, indicating “reset”; when the feedback voltage V_{FB} is higher than the offset voltage V_{OS}, the reset signal S_{R} is logic 1, indicating “not reset”.

The counter 211 comprises a clock input end CK, a reset end R, and an output end O. The clock input end CK of the counter 211 is coupled to the output end of the switch control circuit 120 (the gate of the transistor Q₁) for receiving the switch control signal S_{SW}; the reset end R of the counter 211 is coupled to the output end of the comparator CMP₂ for receiving the reset signal S_{R}; the output end O of the counter 211 is coupled to the switch control circuit 120 for outputting a turn-off signal S_{OFF}.

Since the switch control signal S_{SW} is a periodic signal, the counter 211 counts the number of the rising/falling edges of the switch control signal S_{SW}. When the number of the rising/falling edges of the switch control signal S_{SW} does not reach a predetermined value N_{P}, the output end O of the counter 211 outputs the turn-off signal S_{OFF} with logic 0, indicating “ON”, which allows the switch control circuit 120 to remain normal operation; on the other hand, when the number of the rising/falling edges of the switch control signal S_{SW} reaches the predetermined value N_{P}, the output end O of the counter 211 outputs the turn-off signal S_{OFF} with logic 1, indicating “OFF”, which shuts down the switch control circuit 120.

When the counter 211 receives the reset signal S_{R} with logic 1, the counter 211 keeps counting; otherwise, when the counter receives the reset signal S_{R} with logic 0, the number that the counter 211 counts is reset to 0 and the counter 211 start over counting.

Furthermore, the clock input end CK of the counter 211 does not have to couple to the output end of the switch control circuit 120 for receiving the periodic switch control signal S_{SW}. The circuitry described above is only an exemplary embodiment. The clock input end CK of the counter 211 may receives any signal with periodic character for counting.

Therefore, according to the description above, the counter 211 of the present invention, with a periodic signal, is equivalent to a timer TM. The timer TM may be utilized for counting time. When the time counted by the timer TM is shorter than a predetermined time T_{P}, the timer TM outputs the turn-off signal S_{OFF} with logic 0 for keeping the switch control circuit 120 remaining normal operation; on the other hand, when the time counted by the timer TM is longer than the predetermined time T_{P}, the timer TM outputs the turn-off signal S_{OFF} with logic 1 for shutting down the switch control circuit 120.

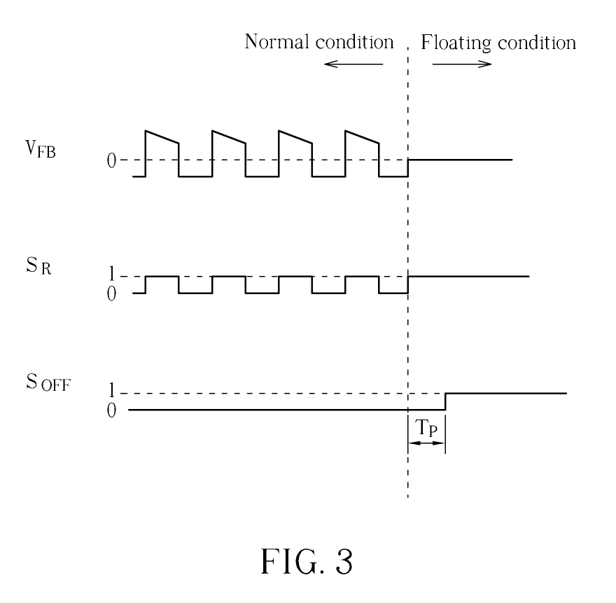

Please refer to FIG. 3. FIG. 3 is a timing diagram illustrating the relation between the feedback voltage, the reset signal, and the turn-off signal of the present invention. As shown in FIG. 3, due to physical nature, in the normal condition, the feedback voltage V_{FB} toggles between a positive value and a negative value. That is, in the normal condition, the feedback voltage V_{FB} is pulled down to be a voltage level that is lower than 0V every a certain period. However, if the resistor R_{FB1} is improperly soldered, which means abnormal condition or floating condition, the feedback voltage V_{FB} is kept at 0V through the resistor R_{FB2} by the voltage source V_{SS}. Therefore, the physical nature described above is utilized by the present invention for detecting if the resistor R_{FB1} is improperly soldered. In other words, if the feedback voltage V_{FB} is pulled down to be a voltage level that is lower than 0V every a certain period (V_{FB}<0V), it is determined that no floating condition occurs by the present invention. On the other hand, if the feedback voltage V_{FB} is kept at 0V, or not pulled down to a negative value, it is determined that the floating condition occurs by the present invention, and the switch control circuit 120 is shut down accordingly.

Thus, according to FIG. 3 and the description above, it is known that the offset voltage V_{OS} has to be appropriately set at a negative voltage level (0V the highest) to determine if the feedback voltage V_{FB} toggles. When the feedback voltage V_{FB} is kept at 0V, which means the feedback voltage V_{FB} is kept to be higher than the offset voltage V_{OS}, the comparator CMP₂ keeps outputting the reset signal S_{R} with logic 1 for not resetting the counter 211, so that the number of the counter 211 is possible to be higher than the predetermined value N_{P}, and when the number of the counter 211 is higher than the predetermined value N_{P}, the turn-off signal S_{OFF} with logic 1, indicating “shut down”, is sent to the switch control circuit 120 for shutting down the switch control circuit 120. From FIG. 3, it can be seen that when the floating condition occurs, after the predetermined time T_{P}, under the condition that the counter 211 is not reset, which means the number of the counter 211 is higher than the predetermined value N_{P}, the counter 211 generates the turn-off signal S_{OFF} indicating “shut down”. In this way, it is ensured that under the floating condition, since the switch control circuit 120 is shut down, the output voltage V_{OUT} will not increase unlimitedly and the components are protected from being damaged by the over-high output voltage.

To sum up, by utilizing the floating protection circuit provided by the present invention, it is effectively to detect floating condition and accordingly shut down the photo-flash capacitor charger, which avoids the output voltage from increasing unlimitedly and saves the components possibly damaged by the output voltage, providing great convenience.

Those skilled in the art will readily observe that numerous modifications and alterations of the device and method may be made while retaining the teachings of the invention.

What is claimed is:

1. A floating protection circuit, utilized for a photo-flash capacitor charger, the photo-flash capacitor charger having a switch control circuit, a transistor, a transformer, a diode, a first comparator, a first feedback resistor, and a second feedback resistor, the floating protection circuit coupled to the switch control circuit, the switch control circuit coupled to a control end of the transistor for outputting a switch control signal, the transistor having a first end, a second end, and the control end, the transistor coupling the first end of the transistor to the second end of the transistor according to the switch control signal, a switch voltage on the first end of the transistor, the transformer having a primary winding and a secondary winding, the first end of the transistor coupled to a first end of the primary winding of the transformer, a second end of the primary winding of the transformer coupled to a second voltage source, a first end of the secondary winding of the transformer coupled to a positive end of the diode, a second end of the secondary winding coupled to the first voltage source, the first feedback resistor coupled between the positive end of the diode and the second feedback resistor, the second resistor coupled between the first feedback resistor and the first voltage, the first comparator having a positive input end, a negative input end, and an output end, the positive input end of the comparator coupled between the first feedback resistor and the second feedback resistor for receiving a feedback voltage, the negative input end of the first comparator receiving a reference voltage, the comparator comparing the reference voltage and the feedback voltage and accordingly generating a result, the switch control circuit outputting the switch control signal according to the switch voltage and the result, the floating protection circuit comprising:
a timer, comprising:
a reset end, for receiving a reset signal; and
an output end, coupled to the switch control circuit, for outputting a turn-off signal;
wherein when the timer does not receive the reset signal for a predetermined time, the timer outputs the turn-off signal;
wherein when the switch control circuit receives the turn-off signal, the switch control circuit is shut down; and
a second comparator, comprising:
a positive input end, coupled between the first feedback resistor and the second resistor for receiving the feedback voltage;
a negative input end for receiving an offset voltage; and
an output end for outputting the reset signal;
wherein when the feedback voltage is lower than the offset voltage, the second comparator outputs the reset signal;
wherein the offset voltage is at a negative voltage level.

2. The floating protection circuit of claim 1, wherein the first voltage source is ground.

3. The floating protection circuit of claim 1, wherein the transistor is an N-channel Metal Oxide Semiconductor (NMOS) transistor.

4. The floating protection circuit of claim 2, wherein the timer comprises:
a counter, comprising:
a clock input end, coupled to the control end of the transistor, for receiving the switch control signal;
a reset end, coupled to the output end of the second comparator, for receiving the reset signal; and
an output end for outputting the turn-off signal;
wherein the counter detects rising edges or falling edges of the switch control signal for counting;
wherein when number that the counter counts reaches to a predetermined value, the counter outputs the turn-off signal;
wherein when the counter receives the reset signal, the number that the counter counts is reset to zero.

5. A photo-flash capacitor charger with floating protection, comprising:
a transformer, comprising:
a primary winding, comprising:
a first end; and
a second end, coupled to a second voltage source; and
a secondary winding, comprising:
a first end; and
a second end, coupled to a first voltage source;
a diode, coupled to the first end of the secondary winding for outputting an output voltage;
a transistor, comprising:
a first end, coupled to the first end of the primary winding;
a second end, coupled to the first voltage source; and
a control end for receiving a switch control signal;
a first feedback resistor coupled to a positive end of the diode;
a second feedback resistor, coupled between the first feedback resistor and the first voltage source, for outputting a feedback voltage;
a first comparator, comprising:
a positive input end, coupled between the first feedback resistor and the second feedback resistor, for receiving the feedback voltage;
a negative input end, for receiving a reference voltage; and
an output end, the first comparator comparing the reference voltage and the feedback voltage and outputting a result at the output end of the first comparator;
a switch control circuit, coupled to the output end of the first comparator, the control end of the transistor, and the first end of the transistor, for outputting the switch control signal according to the result and the switch voltage; and
a floating protection circuit, comprising:
a timer, comprising:
a reset end for receiving a reset signal; and
an output end, coupled to the switch control circuit, for outputting a turn-off signal;
wherein when the timer does not receive the reset signal for a predetermined time, the timer outputs the turn-off signal;
wherein when the switch control circuit receives the turn-off signal, the switch control circuit is shut down; and
a second comparator, comprising:
a positive input end, coupled between the first feedback resistor and the second feedback resistor, for receiving the feedback voltage;
a negative input end, for receiving an offset voltage; and
an output end, for outputting the reset signal;
wherein when the feedback voltage is lower than the offset voltage, the second comparator outputs the reset signal;
wherein the offset voltage is at a negative voltage level.

6. The photo-flash capacitor charger of claim 5, wherein the first voltage source is ground.

7. The photo-flash capacitor charger of claim 5, wherein the transistor is an NMOS transistor.

8. The photo-flash capacitor charger of claim 6, wherein the timer comprises:
a counter, comprising:
a clock input end, coupled to the control end of the transistor, for receiving the switch control signal;
a reset end, coupled to the output end of the second comparator, for receiving the reset signal; and
an output end for outputting the turn-off signal;
wherein the counter detects rising edges or falling edges of the switch control signal for counting;
wherein when number that the counter counts reaches to a predetermined value, the counter outputs the turn-off signal;
wherein when the counter receives the reset signal, the number that the counter counts is reset to zero.
